(19) United States
(12) Patent Application Publication
(10) Pub. No.: US 2010/0041350 A1
(43) Pub. Date: Feb. 18, 2010

(54) Uplink transmissions with two antenna ports

(75) Inventors: Jianzhong Zhang, Irving, TX (US); Young-Han Nam, Plano, TX (US)

Correspondence Address: DOCKET CLERK, P.O. DRAWER 800889, DALLAS, TX, 75380, US

(73) Assignee: Samsung Electronics, Co., Ltd., Suwon-si (KR)

(21) Appl. No.: 12/386,775

(22) Filed: Apr. 22, 2009

Related U.S. Application Data
(60) Provisional application No. 61/188,847, filed on Aug. 13, 2008.

(51) Int. Cl. H04B 7/02; H04B 1/02

(52) U.S. Cl. 455/101; 375/267

(57) ABSTRACT

A system and method for uplink transmit diversity. The system and method include a transmitter configured to pair symbols and transmit at least one the paired symbols and an orphan symbol using a Frequency Shift Transmit Diversity scheme. The system and method include a precoding and resource allocation means configured to map and precode the orphan symbols for transmission on a number of antenna ports. The orphan symbol is mapped to at least two antenna ports using one of even-odd split, top-down split and full mapping. A subscriber station is capable of receiving a cyclic shift assignment explicitly or implicitly.

### CROSS-REFERENCE TO RELATED APPLICATION(S) AND CLAIM OF PRIORITY

The present application is related to U.S. Provisional Patent No. 61/188,847, filed Aug. 13, 2008, entitled “TRANSMIT DIVERSITY SCHEMES FOR UPLINK TRANSMISSIONS WITH 2 ANTENNA PORTS”. Provisional Patent No. 61/188,847 is assigned to the assignee of the present application and is hereby incorporated by reference into the present application as if fully set forth herein. The present application hereby claims priority under 35 U.S.C. §119(e) to U.S. Provisional Patent No. 61/188,847.

### TECHNICAL FIELD OF THE INVENTION

The present application relates generally to wireless communications networks and, more specifically, to diversity schemes for a wireless communication network.

### BACKGROUND OF THE INVENTION

Modern communications demand higher data rates and performance. Multiple input, multiple output (MIMO) antenna systems, also known as multiple-element antenna (MEA) systems, achieve greater spectral efficiency for allocated radio frequency (RF) channel bandwidths by utilizing space or antenna diversity at both the transmitter and the receiver, or in other cases, the transceiver.

In MIMO systems, each of a plurality of data streams is individually mapped and modulated before being precoded and transmitted by different physical antennas or effective antennas. The combined data streams are then received at multiple antennas of a receiver. At the receiver, each data stream is separated and extracted from the combined signal. This process is generally performed using a minimum mean squared error (MMSE) or MMSE-successive interference cancellation (SIC) algorithm.

### SUMMARY OF THE INVENTION

A subscriber station capable of wireless transmissions is provided. The subscriber station includes a transform precoder and a resources mapper. The transform precoder and resource mapper are configured to precode and map at least one symbol onto at least two antenna ports using a frequency shift transmit diversity scheme.

A wireless communications network comprising a plurality of base stations capable of receiving transmissions from a plurality of subscriber stations is provided. At least one of the plurality of subscriber stations includes a transform precoder and a resource mapper. The transform precoder and resource mapper are configured to precode and map at least one symbol onto at least two antenna ports using a frequency shift transmit diversity scheme.

A method for uplink transmissions is provided. The method comprises transmitting at least one symbol of an uplink subframe of symbols via at least two antenna ports using a frequency shift transmit diversity scheme.

A subscriber station capable of wireless transmissions is provided. The subscriber station includes a transform precoder and a resource mapper. The subscriber station is configured to receive a number of cyclic shift assignments. The number of cyclic shift assignments includes an assignment of a first cyclic shift to a first demodulation reference signal and a second cyclic shift to a second demodulation reference signal. The subscriber station utilizes the cyclic shifts in an uplink transmission.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an Orthogonal Frequency Division Multiple Access (OFDMA) wireless network that is capable of decoding data streams according to one embodiment of the present disclosure;

FIG. 2A is a high-level diagram of an OFDMA transmitter according to one embodiment of the present disclosure;

FIG. 2B is a high-level diagram of an OFDMA receiver according to one embodiment of the present disclosure;

FIG. 3A illustrates details of the LTE downlink (DL) physical channel processing according to an embodiment of the present disclosure;

FIG. 3B illustrates details of the LTE uplink (UL) physical channel processing according to an embodiment of the present disclosure;

FIG. 3C illustrates a UL resource grid according to embodiments of the present disclosure;

FIG. 3D illustrates UL subframe structures in LTE according to embodiments of the present disclosure;

FIG. 4 illustrates details of the layer mapper and precoder of FIG. 3A according to one embodiment of the present disclosure;

FIG. 5 illustrates details of an Alamouti STBC with SC-FDMA precoder according to one embodiment of the present disclosure;

FIG. 6 illustrates a transmitter structure for 2-TxD schemes according to one embodiment of the present disclosure;

FIG. 7 illustrates another set of UL subframe structures in LTE according to embodiments of the present disclosure;

FIG. 8 illustrates a pairing operation according to embodiments of the present disclosure;

FIG. 9 illustrates a detailed view of the transmitter components for orphan symbols according to one embodiment of the present disclosure;

FIG. 10 illustrates an even-odd split mapping method according to embodiments of the present disclosure;

FIG. 11 illustrates a top-down split mapping method according to embodiments of the present disclosure;

FIG. 12 illustrates a full mapping method according to embodiments of the present disclosure;

FIGS. 13 and 14 illustrate DM-RS mapping methods according to embodiments of the present disclosure;

FIG. 15 illustrates a DM-RS full mapping method according to embodiments of the present disclosure;

FIG. 16A illustrates an example DM-RS mapping method A according to embodiments of the present disclosure: and

FIG. 16B illustrates an example DM-RS mapping method B according to embodiments of the present disclosure.

### DETAILED DESCRIPTION OF THE INVENTION

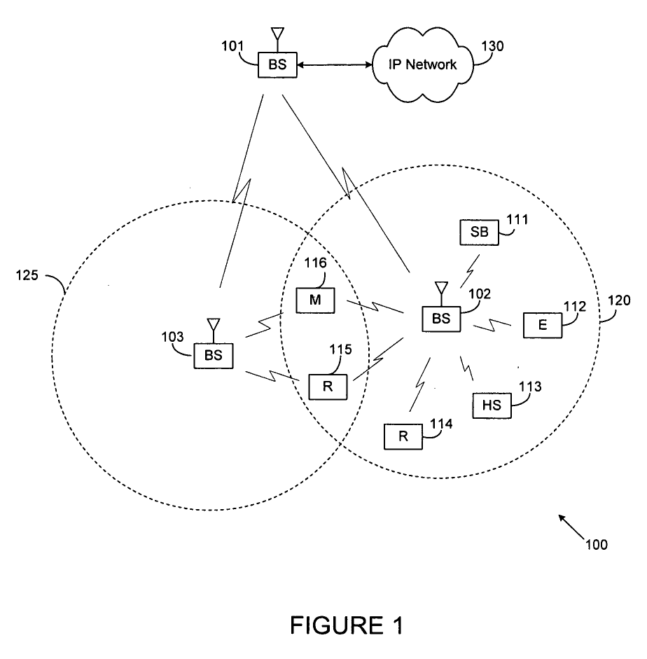

FIGS. 1 through 16B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications network.

With regard to the following description, it is noted that the 3GPP Long Term Evolution (LTE) term “node B” is another term for “base station” used below. Also, the LTE term “user equipment” or “UE” is another term for “subscriber station” used below.

FIG. 1 illustrates exemplary wireless network 100 that is capable of decoding data streams according to one embodiment of the present disclosure. In the illustrated embodiment, wireless network 100 includes base station (BS) 101, base station (BS) 102, and base station (BS) 103. Base station 101 communicates with base station 102 and base station 103. Base station 101 also communicates with Internet protocol (IP) network 130, such as the Internet, a proprietary IP network, or other data network.

Base station 102 provides wireless broadband access to network 130, via base station 101, to a first plurality of subscriber stations within coverage area 120 of base station 102. The first plurality of subscriber stations includes subscriber station (SS) 111, subscriber station (SS) 112, subscriber station (SS) 113, subscriber station (SS) 114, subscriber station (SS) 115 and subscriber station (SS) 116. Subscriber station (SS) may be any wireless communication device, such as, but not limited to, a mobile phone, mobile PDA and any mobile station (MS). In an exemplary embodiment, SS 111 may be located in a small business (SB), SS 112 may be located in an enterprise (E), SS 113 may be located in a WiFi hotspot (HS), SS 114 may be located in a first residence, SS 115 may be located in a second residence, and SS 116 may be a mobile (M) device.

Base station 103 provides wireless broadband access to network 130, via base station 101, to a second plurality of subscriber stations within coverage area 125 of base station 103. The second plurality of subscriber stations includes subscriber station 115 and subscriber station 116. In alternate embodiments, base stations 102 and 103 may be connected directly to the Internet by means of a wired broadband connection, such as an optical fiber, DSL, cable or T1/E1 line, rather than indirectly through base station 101.

In other embodiments, base station 101 may be in communication with either fewer or more base stations. Furthermore, while only six subscriber stations are shown in FIG. 1, it is understood that wireless network 100 may provide wireless broadband access to more than six subscriber stations. It is noted that subscriber station 115 and subscriber station 116 are on the edge of both coverage area 120 and coverage area 125. Subscriber station 115 and subscriber station 116 each communicate with both base station 102 and base station 103 and may be said to be operating in handoff mode, as known to those of skill in the art.

In an exemplary embodiment, base stations 101-103 may communicate with each other and with subscriber stations 111-116 using an IEEE-802.16 wireless metropolitan area network standard, such as, for example, an IEEE-802.16e standard. In another embodiment, however, a different wireless protocol may be employed, such as, for example, a HIPERMAN wireless metropolitan area network standard. Base station 101 may communicate through direct line-of-sight or non-line-of-sight with base station 102 and base station 103, depending on the technology used for the wireless backhaul. Base station 102 and base station 103 may each communicate through non-line-of-sight with subscriber stations 111-116 using OFDM and/or OFDMA techniques.

Base station 102 may provide a T1 level service to subscriber station 112 associated with the enterprise and a fractional T1 level service to subscriber station 111 associated with the small business. Base station 102 may provide wireless backhaul for subscriber station 113 associated with the WiFi hotspot, which may be located in an airport, café, hotel, or college campus. Base station 102 may provide digital subscriber line (DSL) level service to subscriber stations 114, 115 and 116.

Subscriber stations 111-116 may use the broadband access to network 130 to access voice, data, video, video teleconferencing, and/or other broadband services. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer, a laptop computer, a gateway, or another device.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Also, the coverage areas associated with base stations are not constant over time and may be dynamic (expanding or contracting or changing shape) based on changing transmission power levels of the base station and/or the subscriber stations, weather conditions, and other factors. In an embodiment, the radius of the coverage areas of the base stations, for example, coverage areas 120 and 125 of base stations 102 and 103, may extend in the range from less than 2 kilometers to about fifty kilometers from the base stations.

As is well known in the art, a base station, such as base station 101, 102, or 103, may employ directional antennas to support a plurality of sectors within the coverage area. In FIG. 1, base stations 102 and 103 are depicted approximately in the center of coverage areas 120 and 125, respectively. In other embodiments, the use of directional antennas may locate the base station near the edge of the coverage area, for example, at the point of a cone-shaped or pear-shaped coverage area.

The connection to network 130 from base station 101 may comprise a broadband connection, for example, a fiber optic line, to servers located in a central office or another operating company point-of-presence. The servers may provide communication to an Internet gateway for internet protocol-based communications and to a public switched telephone network gateway for voice-based communications. In the case of voice-based communications in the form of voice-over-IP (VoIP), the traffic may be forwarded directly to the Internet gateway instead of the PSTN gateway. The servers, Internet gateway, and public switched telephone network gateway are not shown in FIG. 1. In another embodiment, the connection to network 130 may be provided by different network nodes and equipment.

In accordance with an embodiment of the present disclosure, one or more of base stations 101-103 and/or one or more of subscriber stations 111-116 comprises a receiver that is operable to decode a plurality of data streams received as a combined data stream from a plurality of transmit antennas using an MMSE-SIC algorithm. As described in more detail below, the receiver is operable to determine a decoding order for the data streams based on a decoding prediction metric for each data stream that is calculated based on a strength-related characteristic of the data stream. Thus, in general, the receiver is able to decode the strongest data stream first, followed by the next strongest data stream, and so on. As a result, the decoding performance of the receiver is improved as compared to a receiver that decodes streams in a random or pre-determined order without being as complex as a receiver that searches all possible decoding orders to find the optimum order.

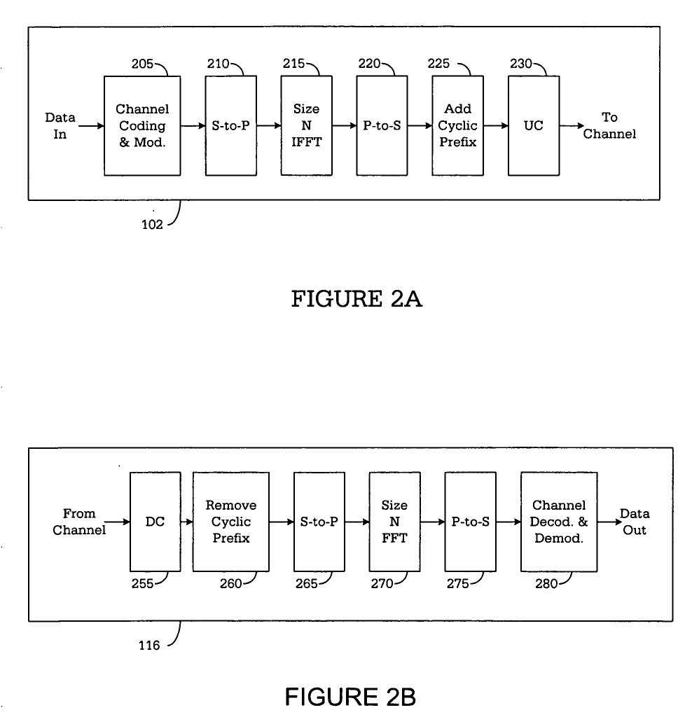

FIG. 2A is a high-level diagram of an orthogonal frequency division multiple access (OFDMA) transmit path. FIG. 2B is a high-level diagram of an orthogonal frequency division multiple access (OFDMA) receive path. In FIGS. 2A and 2B, the OFDMA transmit path is implemented in base station (BS) 102 and the OFDMA receive path is implemented in subscriber station (SS) 116 for the purposes of illustration and explanation only. However, it will be understood by those skilled in the art that the OFDMA receive path may also be implemented in BS 102 and the OFDMA transmit path may be implemented in SS 116.

The transmit path in BS 102 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. The receive path in SS 116 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 2B may be implemented in software while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In BS 102, channel coding and modulation block 205 receives a set of information bits, applies coding (e.g., Turbo coding) and modulates (e.g., QPSK, QAM) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at SS 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of base stations 101-103 may implement a transmit path that is analogous to transmitting in the downlink to subscriber stations 111-116 and may implement a receive path that is analogous to receiving in the uplink from subscriber stations 111-116. Similarly, each one of subscriber stations 111-116 may implement a transmit path corresponding to the architecture for transmitting in the uplink to base stations 101-103 and may implement a receive path corresponding to the architecture for receiving in the downlink from base stations 101-103.

The present disclosure describes methods and systems to convey information relating to base station configuration to subscriber stations and, more specifically, to relaying base station antenna configuration to subscriber stations. This information can be conveyed through a plurality of methods, including placing antenna configuration into a quadrature-phase shift keying (QPSK) constellation (e.g., n-quadrature amplitude modulation (QAM) signal, wherein n is 2̂x) and placing antenna configuration into the error correction data (e.g., cyclic redundancy check (CRC) data). By encoding antenna information into either the QPSK constellation or the error correction data, the base stations 101-103 can convey base stations 101-103 antenna configuration without having to separately transmit antenna configuration. These systems and methods allow for the reduction of overhead while ensuring reliable communication between base stations 101-103 and a plurality of subscriber stations.

In some embodiments disclosed herein, data is transmitted using QAM. QAM is a modulation scheme which conveys data by modulating the amplitude of two carrier waves. These two waves are referred to as quadrature carriers, and are generally out of phase with each other by 90 degrees. QAM may be represented by a constellation that comprises 2̂x points, where x is an integer greater than 1. In the embodiments discussed herein, the constellations discussed will be four point constellations (4-QAM). In a 4-QAM constellation, a 2 dimensional graph is represented with one point in each quadrant of the 2 dimensional graph. However, it is explicitly understood that the innovations discussed herein may be used with any modulation scheme with any number of points in the constellation. It is further understood that with constellations with more than four points additional information (e.g., reference power signal) relating to the configuration of the base stations 101-103 may be conveyed consistent with the disclosed systems and methods.

It is understood that the transmitter within base stations 101-103 performs a plurality of functions prior to actually transmitting data. In the 4-QAM embodiment, QAM modulated symbols are serial-to-parallel converted and input to an inverse fast Fourier transform (IFFT). At the output of the IFFT, N time-domain samples are obtained. In the disclosed embodiments, N refers to the IFFT/fast Fourier transform (FFT) size used by the OFDM system. The signal after IFFT is parallel-to-serial converted and a cyclic prefix (CP) is added to the signal sequence. The resulting sequence of samples is referred to as an OFDM symbol.

At the receiver within the subscriber station, this process is reversed, and the cyclic prefix is first removed. Then the signal is serial-to-parallel converted before being fed into the FFT. The output of the FFT is parallel-to-serial converted, and the resulting QAM modulation symbols are input to the QAM demodulator.

The total bandwidth in an OFDM system is divided into narrowband frequency units called subcarriers. The number of subcarriers is equal to the FFT/IFFT size N used in the system. In general, the number of subcarriers used for data is less than N because some subcarriers at the edge of the frequency spectrum are reserved as guard subcarriers. In general, no information is transmitted on guard subcarriers.

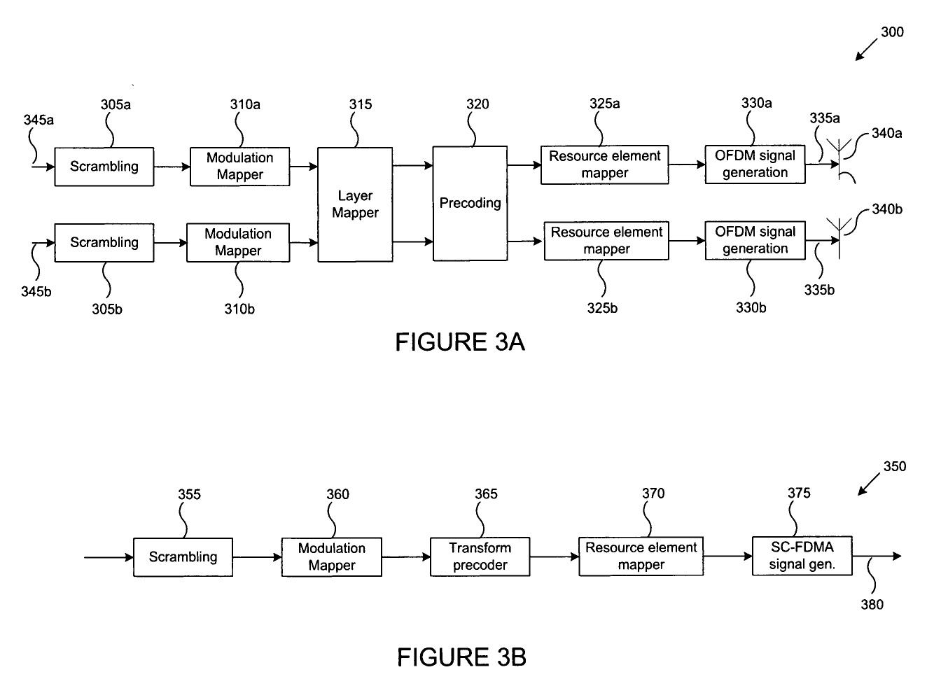

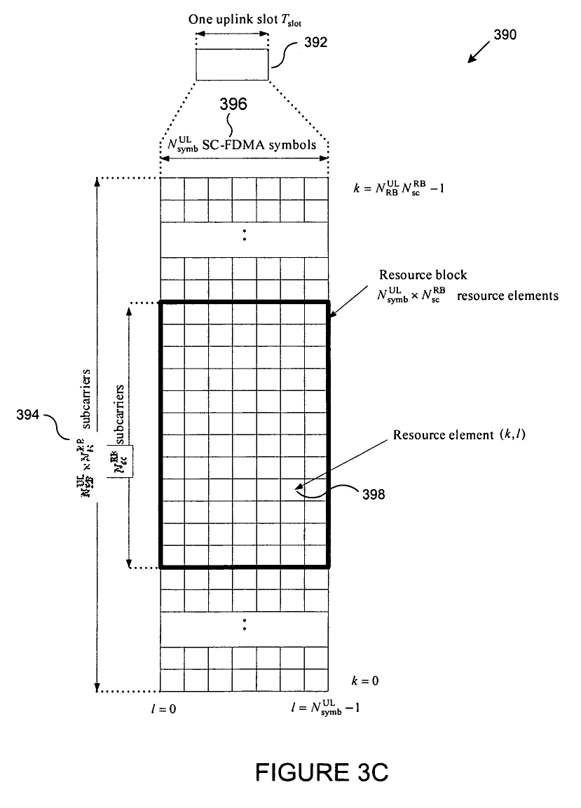

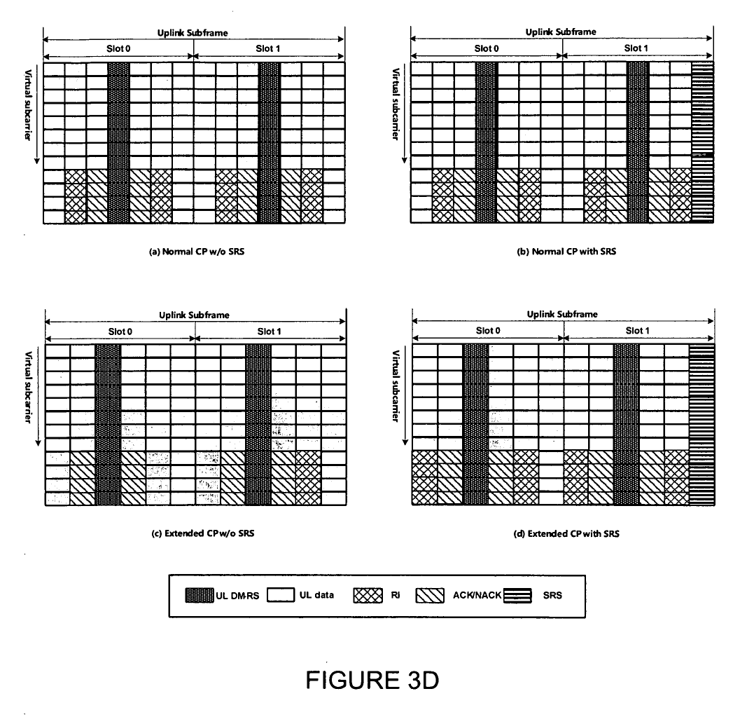

FIG. 3A illustrates details of the LTE downlink (DL) physical channel 300 processing according to an embodiment of the present disclosure. The embodiment of the DL physical channel 300 shown in FIG. 3A is for illustration only. Other embodiments of the DL physical channel 300 could be used without departing from the scope of this disclosure.

For this embodiment, physical channel 300 comprises a plurality of scrambler blocks 305, a plurality of modulation mapper blocks 310, a layer mapper 315, a precoding block 320 (hereinafter “precoding”), a plurality of resource element mappers 325, and a plurality of OFDM signal generation blocks 330. The embodiment of the DL physical channel 300 illustrated in FIG. 3A is applicable to more than one physical channel. Although the illustrated embodiment shows two sets of components 305, 310, 325 and 330 to generate two streams 335a-b for transmission by two antenna ports 3405a-b, it will be understood that physical channel 300 may comprise any suitable number of component sets 305, 310, 325 and 330 based on any suitable number of streams 335 to be generated.

The DL physical channel 300 is operable to scramble coded bits in each code word 345 to be transmitted on the DL physical channel 300. The plurality of scrambler blocks 305 are operable to scramble each code word 345a-345b according to Equation 1:

\tilde{b}^{q}(i)=(b^{q}(i)+c^{q}(i))mod 2. [Eqn: 1]

In Equation 1, b^{(q)}(0), . . . , b^{(q)}(M_{bit}^{(q)}−1) is the block of bits for code word q, M_{bit}^{(q)} is the number of bits in code word q, and c^{q}(i) is the scrambling sequence.

The DL physical channel 300 further is operable to perform modulation of the scrambled bits. The plurality of modulation blocks 310 modulate the block of scrambled bits b^{(q)}(0), . . . , b^{(q)}(M_{bit}^{(q)}−1). The block of scrambled bits b^{(q)}(0), . . . , b^{(q)}(M_{bit}^{(q)}−1) is modulated using one of a number of modulation schemes including, quad phase shift keying (QPSK), sixteen quadrature amplitude modulation (16QAM), and sixty-four quadrature amplitude modulation (64QAM) for each of a physical downlink shared channel (PDSCH) and physical multicast channel (PMCH). Modulation of the scrambled bits by the plurality of modulation blocks 310 yields a block of complex-valued modulation symbols d^{(q)}(0), . . . , d^{(q)}(M_{symb}^{(q)}−1).

Further, the DL physical channel 300 is operable to perform layer mapping of the modulation symbols. The layer mapper 315 maps the complex-valued modulation symbols d^{(q)}(0), . . . , d^{(q)}(M_{symb}^{(q)}−1) onto one or more layers. Complex-valued modulation symbols d^{(q)}(0), . . . , d^{(q)}(M_{symb}^{(q)}−1) for code word q are mapped onto one or more layers, x(i), as defined by Equation 2:

x(i)=[x⁽⁰⁾(i) . . . x^{(υ-1)}(i)]^{T}. [Eqn. 2]

In Equation 2, i=0, 1, . . . , M_{symb}^{layer}−1, υ is the number of layers and M_{symb}^{layer} is the number of modulation symbols per layer.

For transmit diversity, the layer mapping 315 is performed according to Table 1.

TABLE 1
Code word-to-layer mapping for transmit diversity

| | Number of | | |
|---|---|---|---|
| Number of | code | Code word-to-layer | |
| Layers | words | mapping i = 0, 1, . . . , M_{symb}^{layer} − 1 | |
| 2 | 1 | x⁽⁰⁾(i) = d⁽⁰⁾(2i) | M_{symb}^{layer} = M_{symb}⁽⁰⁾/2 |
| | | x⁽¹⁾(i) = d⁽⁰⁾(2i + 1) | |
| 4 | 1 | x⁽⁰⁾(i) = d⁽⁰⁾(4i) | M_{symb}^{layer} = M_{symb}⁽⁰⁾/4 |
| | | x⁽¹⁾(i) = d⁽⁰⁾(4i + 1) | |
| | | x⁽²⁾(i) = d⁽⁰⁾(4i + 2) | |
| | | x⁽³⁾(i) = d⁽⁰⁾(4i + 3) | |

In Table 1, there is only one code word. Further, the number of layers υ is equal to the number of antenna ports P used for transmission of the DL physical channel 300.

Thereafter, precoding 320 is performed on the one or more layers. Precoding 320 can be used for multi-layer beam-forming in order to maximize the throughput performance of a multiple receive antenna system. The multiple streams of the signals are emitted from the transmit antennas with independent and appropriate weighting per each antenna such that the link through-put is maximized at the receiver output. Precoding algorithms for multi-codeword MIMO can be sub-divided into linear and nonlinear precoding types. Linear precoding approaches can achieve reasonable throughput performance with lower complexity related to nonlinear precoding approaches. Linear precoding includes unitary precoding and zero-forcing (hereinafter “ZF”) precoding. Nonlinear precoding can achieve near optimal capacity at the expense of complexity. Nonlinear precoding is designed based on the concept of Dirty Paper Coding (hereinafter “DPC”) which shows that any known interference at the transmitter can be subtracted without the penalty of radio resources if the optimal precoding scheme can be applied on the transmit signal.

Precoding 320 for transmit diversity is used only in combination with layer mapping 315 for transmit diversity, as described herein above. The precoding 320 operation for transmit diversity is defined for two and four antenna ports. The output of the precoding operation for two antenna ports (Pε{0, 1}) is defined by Equations 3 and 4:

$$\begin{matrix}y ( i ) = {[ {y}^{( 0 )} ( i ) {y}^{( 1 )} ( i ) ]}^{T} ; \\ where \text{:} & [ Eqn . 3 ] \\ [ \begin{matrix}{y}^{( 0 )} ( 2 i ) \\ {y}^{( 1 )} ( 2 i ) \\ {y}^{( 0 )} ( 2 i + 1 ) \\ {y}^{( 1 )} ( 2 i + 1 )\end{matrix} ] = \frac{1}{\sqrt{2}} [ \begin{matrix}1 & 0 & j & 0 \\ 0 & - 1 & 0 & j \\ 0 & 1 & 0 & j \\ 1 & 0 & - j & 0\end{matrix} ] [ \begin{matrix}Re ( {x}^{( 0 )} ( i ) ) \\ Re ( {x}^{( 1 )} ( i ) ) \\ Im ( {x}^{( 0 )} ( i ) ) \\ Im ( {x}^{( 1 )} ( i ) )\end{matrix} ] , \\ for i = 0 , 1 , … , {M}_{symb}^{layer} - 1 with {M}_{symb}^{ap} = 2 {M}_{symb}^{layer} . & [ Eqn . 4 ]\end{matrix}$$

The output of the precoding operation for four antenna ports (Pε{0, 1, 2, 3}) is defined by Equations 5 and 6:

$$\begin{matrix}y ( i ) = {[ \begin{matrix}{y}^{( 0 )} ( i ) & {y}^{( 1 )} ( i ) & {y}^{( 2 )} ( i ) & {y}^{( 3 )} ( i )\end{matrix} ]}^{T} , \\ where \text{:} & [ Eqn . 5 ] \\ [ \begin{matrix}{y}^{( 0 )} ( 4 i ) \\ {y}^{( 1 )} ( 4 i ) \\ {y}^{( 2 )} ( 4 i ) \\ {y}^{( 3 )} ( 4 i ) \\ {y}^{( 0 )} ( 4 i + 1 ) \\ {y}^{( 1 )} ( 4 i + 1 ) \\ {y}^{( 2 )} ( 4 i + 1 ) \\ {y}^{( 3 )} ( 4 i + 1 ) \\ {y}^{( 0 )} ( 4 i + 2 ) \\ {y}^{( 1 )} ( 4 i + 2 ) \\ {y}^{( 2 )} ( 4 i + 2 ) \\ {y}^{( 3 )} ( 4 i + 2 ) \\ {y}^{( 0 )} ( 4 i + 3 ) \\ {y}^{( 1 )} ( 4 i + 3 ) \\ {y}^{( 2 )} ( 4 i + 3 ) \\ {y}^{( 3 )} ( 4 i + 3 )\end{matrix} ] = \frac{1}{\sqrt{2}} [ \begin{matrix}1 & 0 & 0 & 0 & j & 0 & 0 & 0 \\ 0 & 0 & 0 & 0 & 0 & 0 & 0 & 0 \\ 0 & - 1 & 0 & 0 & 0 & j & 0 & 0 \\ 0 & 0 & 0 & 0 & 0 & 0 & 0 & 0 \\ 0 & 1 & 0 & 0 & 0 & j & 0 & 0 \\ 0 & 0 & 0 & 0 & 0 & 0 & 0 & 0 \\ 1 & 0 & 0 & 0 & - j & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 1 & 0 & 0 & 0 & j & 0 \\ 0 & 0 & 0 & 0 & 0 & 0 & 0 & 0 \\ 0 & 0 & 0 & - 1 & 0 & 0 & 0 & j \\ 0 & 0 & 0 & 0 & 0 & 0 & 0 & 0 \\ 0 & 0 & 0 & 1 & 0 & 0 & 0 & j \\ 0 & 0 & 0 & 0 & 0 & 0 & 0 & 0 \\ 0 & 0 & 1 & 0 & 0 & 0 & - j & 0\end{matrix} ] [ \begin{matrix}Re ( {x}^{( 0 )} ( i ) ) \\ Re ( {x}^{( 1 )} ( i ) ) \\ Re ( {x}^{( 2 )} ( i ) ) \\ Re ( {x}^{( 3 )} ( i ) ) \\ Im ( {x}^{( 0 )} ( i ) ) \\ Im ( {x}^{( 1 )} ( i ) ) \\ Im ( {x}^{( 2 )} ( i ) ) \\ Im ( {x}^{( 3 )} ( i ) )\end{matrix} ] , \\ for i = 0 , 1 , … , {M}_{symb}^{layer} - 1 with {M}_{symb}^{ap} = 4 {M}_{symb}^{layer} . & [ Eqn . 6 ]\end{matrix}$$

After precoding 320, the resource elements are mapped by the resource element mapper(s) 325. For each of the antenna ports 340 used for transmission of the DL physical channel 300, the block of complex-valued symbols y^{(p)}(0), . . . , y^{(p)}(M_{symb}^{ap}−1) are mapped in sequence. The mapping sequence is started by mapping y^{(p)}(0) to resource elements (k,l) in physical resource blocks corresponding to virtual resource blocks assigned for transmission and not used for transmission of Physical Control Format Indicator Channel (PCFICH), Physical Hybrid Automatic Repeat Request Indicator Channel (PHICH), primary broadcast channel (PBCH), synchronization signals or reference signals. The mapping to resource elements (k,l) on antenna port (P) not reserved for other purposes shall be in increasing order of first the index k over the assigned physical resource blocks and then the index l, starting with the first slot in a subframe.

FIG. 3B illustrates details of the LTE uplink (UL) physical channel 350 processing according to an embodiment of the present disclosure. The embodiment of the UL physical channel 350 shown in FIG. 3B is for illustration only. Other embodiments of the UL physical channel 350 could be used without departing from the scope of this disclosure.

For this embodiment, a single-carrier frequency-dependent multiple access (SC-FDMA) is adopted as the basic transmission scheme. The UL physical channel 350 comprises a scrambling block 355, a modulation mapper 360, a transform precoder 365, a resource element mapper 370, and SC-FDMA signal generation block 375. The embodiment of the UL physical channel 350 illustrated in FIG. 3B is applicable to more than one UL physical channel. Although the illustrated embodiment shows one component 355, 360, 365, 370 and 375 to generate one stream 380 for transmission, it will be understood that UL physical channel 350 may comprise any suitable number of component sets 355, 360, 365, 370 and 375 based on any suitable number of streams 380 to be generated. At least some of the components in FIGS. 3A and 3B may be implemented in software while other components may be implemented by configurable hardware or a mixture of software and configurable hardware.

The scrambling block 355 is operable to scramble coded bits to be transmitted on the UL physical channel 350. The UL physical channel 350 further is operable to perform modulation of the scrambled bits. The modulation block 360 modulates the block of scrambled bits \tilde{b}(0), . . . , \tilde{b}(M_{bit}−1). The block of scrambled bits \tilde{b}(0), . . . , \tilde{b}(M_{bit}−1) is modulated using one of a number of modulation schemes including, quad phase shift keying (QPSK), sixteen quadrature amplitude modulation (16QAM), and sixty-four quadrature amplitude modulation (64QAM) for each of a physical downlink shared channel (PDSCH) and physical multicast channel (PMCH). Modulation of the scrambled bits by the plurality of modulation blocks 310 yields a block of complex-valued modulation symbols d(0), . . . , d(M_{symb}−1).

Thereafter, the UL physical channel 350 is operable to perform transform precoding on the block of complex-valued modulation symbols d(0), . . . , d(M_{symb}−1). The transform precoder 365 divides the complex-valued modulation symbols, d(0), . . . , d(M_{symb}−1), into M_{symb}/M_{sc}^{PUSCH} sets. Each set corresponds to one SC-FDMA symbol. Transform precoder 365 applies transform precoding using Equation 7:

$$z ( l \cdot {M}_{sc}^{PUSCH} + k ) = \frac{1}{\sqrt{{M}_{sc}^{PUSCH}}} {\sum }_{i = 0}^{{M}_{sc}^{PUSCH} - 1} d ( l \cdot {M}_{sc}^{PUSCH} + i ) {e}^{- j \frac{2 π i k}{{M}_{sc}^{PUSCH}}} \\ k = 0 , … , {M}_{sc}^{PUSCH} - 1 \\ l = 0 , … , {M}_{symb} / {M}_{sc}^{PUSCH} - 1. \qquad [ Eqn . 7 ]$$

Using Equation 7 produces a block of complex-valued symbols z(0), . . . , z(M_{symb}−1). In Equation 7, the variable M_{sc}^{PUSCH}=M_{RB}^{PUSCH}·N_{sc}^{RB}, where M_{RB}^{PUSCH} represents the bandwidth of the PUSCH in terms of resource blocks. M_{RB}^{PUSCH} fulfills Equation 8:

M_{RB}^{PUSCH}=2^{α}^{₂}·3^{α}^{₃}·5^{α}^{₅}≦N_{RB}^{UL}. [Eqn. 8]

In Equation 8, α₂, α₃, and α₅ are a set of non-negative integers.

The resource element mapper 370 maps the complex-valued symbols z(0), . . . , z(M_{symb}−1). The resource element mapper 370 multiplies the complex-valued symbols z(0), . . . , z(M_{symb}−1) with an amplitude scaling factor β_{PUSCH}. The resource element mapper 370 maps the complex-valued symbols z(0), . . . , z(M_{symb}−1) in sequence, starting with z(0), to physical resource blocks assigned for transmission of PUSCH. The mapping to resource elements (k,l) corresponding to the physical resource blocks assigned for transmission, and not used for transmission of reference signals, shall be in increasing order of: first the index k; then the index l; starting with the first slot in the subframe.

FIG. 3C illustrates an UL resource grid 390 according to embodiments of the present disclosure. The embodiment of the UL resource grid 390 shown in FIG. 3C is for illustration only. Other embodiments of the UL resource grid 390 could be used without departing from the scope of this disclosure.

The transmitted signal in each slot 392 is described by a resource grid of N_{RB}^{UL}N_{sc}^{RB} subcarriers 394 and N_{symb}^{UL} SC-FDMA symbols 396. Each element in the UL resource grid 390 is referred to as a resource element 398. Each resource element 398 is uniquely defined by an index pair (k,l) in a slot where k=0, . . . , N_{RB}^{UL}N_{sc}^{RB}−1 and l=0, . . . , N_{symb}^{UL}−1 are indices in the frequency and time domain, respectively. A resource element (k,l) 398 corresponds to a complex value a_{k,l}. The quantities of a_{k,l} corresponding to resource elements 398 not used for transmission of a physical channel or a physical signal in a slot are set to zero (0).

FIG. 3D illustrates UL subframe structures in LTE according to embodiments of the present disclosure. The embodiment of the subframe structures shown in FIG. 3D is for illustration only. Other embodiments of the subframe structure could be used without departing from the scope of this disclosure.

A UL subframe in an LTE system is composed of two time slots. Depending on the hopping configuration, the two slots in a subframe may or may not exist over the same set of subcarriers. A time slot is composed of a different number of SC-FDMA symbols in a normal cyclic-prefix (CP) slot and in an extended CP slot. A normal CP slot is composed of seven (7) SC-FDMA symbols, while an extended CP slot is composed of six (6) SC-FDMA symbols. A slot has demodulation reference signals (DM-RS) in one symbol. At times, a sounding reference signal (SRS) is transmitted. In such cases, one SC-FDMA symbol in the second time slot in a subframe is reserved for the SRS in addition to the DM-RS. Embodiments of the present disclosure provide for four different combinations for the UL subframe structure, as illustrated in FIG. 3D, depending upon the existence of SRS and normal/extended CPs. The number of data symbols in a time slot excluding reference symbols can be either even or odd, depending upon the configuration. For example, as illustrated by FIG. 3D-(a), in the configuration of normal CP without SRS, the number of data symbol is six (6) for both slot 0 and slot 1. However, as illustrated by FIG. 3D-(d) in the configuration of extended CP with SRS, the number of data symbol is five (5) for slot 0, while the number is four (4) for slot 1.

A reference signal sequence, r_{u,v}^{(α)}(n), is defined by a cyclic shift α of a base sequence r̅_{u,v}(n) according to Equation 9:

r_{u,v}^{(α)}(n)=e^{jαn} r̅_{u,v}(n), 0≦n≦M_{sc}^{RS} [Eqn. 9]

In Equation 9, M_{sc}^{RS}=mN_{sc}^{RB} is the length of the reference signal sequence and 1≦m≦N_{RB}^{max,UL}. Multiple reference signal sequences are defined from a single base sequence through different values of α. Base sequences r̅_{u,v}(n) are divided into groups, where uε{0, 1, . . . , 29} is the group number and v is the base sequence number within the group, such that each group contains one base sequence (v=0) of each length M_{sc}^{RS}=mN_{sc}^{RB}, 1≦m≦5 and two base sequences (v=0,1) of each length M_{sc}^{RS}=mN_{sc}^{RB}, and 6≦m≦N_{RB}^{max,UL}.

The demodulation reference signal sequence for PUSCH is defined by Equation 10:

r^{PUSCH}(m·M_{sc}^{RS}+n)=r_{u,v}^{(α)}(n), [Eqn. 10]

where m=0,1; n=0, . . . , M_{sc}^{RS}−1; and M_{sc}^{RS}=M_{sc}^{PUSCH}.

The cyclic shift α in a slot is defined by Equation 11:

α=2πn_{cs}/12 [Eqn. 11]

In Equation 11, n_{cs} further is defined by Equation 12:

n_{cs}=(n_{DMRS}⁽¹⁾+n_{DMRS}⁽²⁾+n_{PRS})mod 12 [Eqn. 12]

In Equation 12, n_{DMRS}⁽¹⁾ is a broadcasted value, n_{DMRS}⁽²⁾ is included in the uplink scheduling assignment and n_{PRS} is given by the pseudo-random sequence c(i) defined in section 7.2 in “3GPP TS 36211 V8.3.0, ‘3^{rd} Generation Partnership Project; Technical Specification Group Radio Access Network; Evolved Universal Terrestrial Radio Access (E-UTRA); Physical Channels and Modulation (Release 8)’, May 2008”, the contents of which are incorporated herein by reference. The application of c(i) is cell-specific. The values of n_{DMRS}⁽²⁾ are given in Table 2.

TABLE 2
Mapping of Cyclic Shift Field in DCI format 0 to n_{DMR}⁽²⁾ Values.

| Cyclic Shift Field in | |
|---|---|
| DCI format 0 | n_{DMR}⁽²⁾ |
| 000 | 0 |
| 001 | 2 |
| 010 | 3 |
| 011 | 4 |
| 100 | 6 |
| 101 | 8 |
| 110 | 9 |
| 111 | 10 |

The pseudo-random sequence generator is initialized at the beginning of each radio frame by Equation 13:

$${c}_{init} = ⌊ \frac{{N}_{ID}^{cell}}{30} ⌋ \cdot {2}^{5} + {f}_{ss}^{PUSCH} \qquad [ Eqn . 13 ]$$

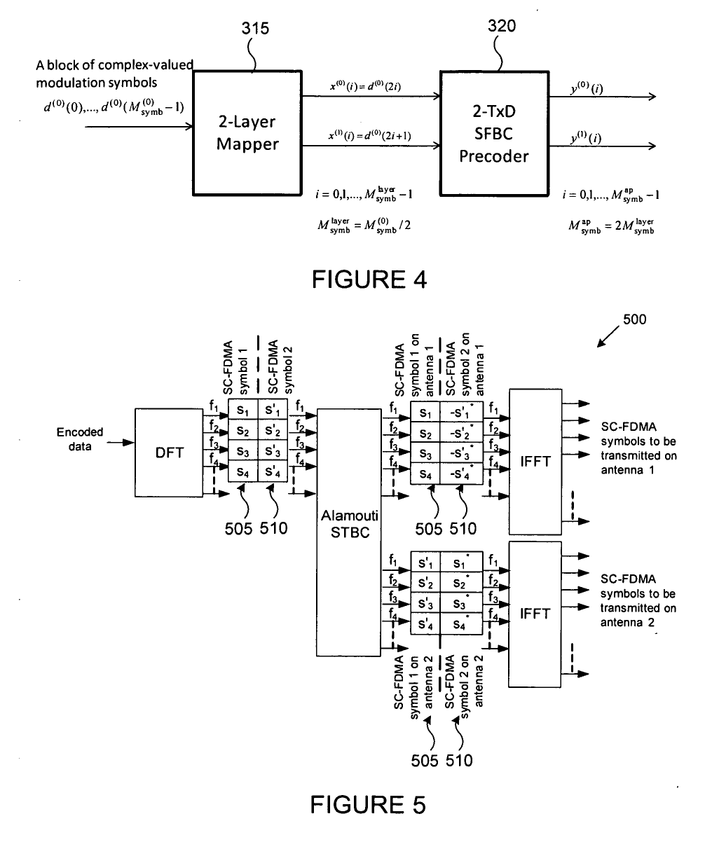

FIG. 4 illustrates details of the layer mapper 315 and precoder 320 of FIG. 3A according to one embodiment of the present disclosure. The embodiment of the layer mapper 315 and precoder 320 shown in FIG. 4 is for illustration only. Other embodiments of the layer mapper 315 and precoder 320 could be used without departing from the scope of this disclosure.

In some embodiments, a two-layer transmit diversity (TxD) precoding scheme is the Alamouti scheme. In such embodiment, the precoder output is defined by Equation 14:

$$\begin{matrix}[ \begin{matrix}{y}^{( 0 )} ( 2 i ) \\ {y}^{( 1 )} ( 2 i ) \\ {y}^{( 0 )} ( 2 i + 1 ) \\ {y}^{( 1 )} ( 2 i + 1 )\end{matrix} ] = \frac{1}{\sqrt{2}} [ \begin{matrix}Re ( {x}^{( 0 )} ( i ) ) + j Im ( {x}^{( 0 )} ( i ) ) \\ - Re ( {x}^{( 1 )} ( i ) ) + j Im ( {x}^{( 1 )} ( i ) ) \\ Re ( {x}^{( 1 )} ( i ) ) + j Im ( {x}^{( 1 )} ( i ) ) \\ Re ( {x}^{( 0 )} ( i ) ) - j Im ( {x}^{( 0 )} ( i ) )\end{matrix} ] \\ = \frac{1}{\sqrt{2}} [ \begin{matrix}{x}^{( 0 )} ( i ) \\ - {( {x}^{( 1 )} ( i ) )}^{*} \\ {x}^{( 1 )} ( i ) \\ {( {x}^{( 0 )} ( i ) )}^{*}\end{matrix} ] .\end{matrix} \qquad [ Eqn . 14 ]$$

In Equation 14, ( )* denotes the complex conjugate and is equivalent to Equation 15:

$$[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 )\end{matrix} ] = \frac{1}{\sqrt{2}} [ \begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*}\end{matrix} ] . \qquad [ Eqn . 15 ]$$

In Equation 15, the precoded signal matrix of the Alamouti scheme is denoted as X_{Alamouti}(i) as illustrated by Equation 16:

$$[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 )\end{matrix} ] = {X}_{Alamouti} ( i ) ≡ \frac{1}{\sqrt{2}} [ \begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*}\end{matrix} ] . \qquad [ Eqn . 16 ]$$

The receiver algorithm for the Alamouti scheme can be efficiently designed by exploiting the orthogonal structure of the received signal. For example, for a receiver with one receive antenna, and denoting the channel gains between transmit (Tx) antenna (Tx layer) P and the receive antenna for i=0, 1, . . . , M_{symb}^{layer}−1 by h^{(p)}(i), a matrix equation for the relation between the received signal and the transmitted signal is defined by Equations 17a and 17b:

$$\begin{matrix}r ( 2 i ) = \frac{1}{\sqrt{2}} [ \begin{matrix}{h}^{( 0 )} ( 2 i ) & {h}^{( 1 )} ( 2 i )\end{matrix} ] [ \begin{matrix}{x}^{( 0 )} ( i ) \\ - {( {x}^{( 1 )} ( i ) )}^{*}\end{matrix} ] + n ( 2 i ) . & [ Eqn . 17 a ] \\ r ( 2 i + 1 ) = \frac{1}{\sqrt{2}} [ \begin{matrix}{h}^{( 0 )} ( 2 i + 1 ) & {h}^{( 1 )} ( 2 i + 1 )\end{matrix} ] [ \begin{matrix}{x}^{( 1 )} ( i ) \\ {( {x}^{( 0 )} ( i ) )}^{*}\end{matrix} ] + n ( 2 i + 1 ) . & [ Eqn . 17 b ]\end{matrix}$$

In Equations 17a and 17b, r(2i) and r(2i+1) are the received signals and n(2i) and n(2i+1) are the received noises in the corresponding resource element. If h⁽⁰⁾(2i)=h⁽⁰⁾(2i+1) and h⁽¹⁾(2i)=h⁽¹⁾(2i+1), then Equations 17a and 17b can be rewritten as Equation 18, facilitating the detection of x⁽⁰⁾(i) and −(x⁽¹⁾(i))*:

$$[ \begin{matrix}r ( 2 i ) \\ {( r ( 2 i + 1 ) )}^{*}\end{matrix} ] = [ \begin{matrix}{h}^{( 0 )} ( 2 i ) & {h}^{( 1 )} ( 2 i ) \\ {( {h}^{( 1 )} ( 2 i ) )}^{*} & - {( {h}^{( 0 )} ( 2 i ) )}^{*}\end{matrix} ] [ \begin{matrix}{x}^{( 0 )} ( i ) \\ - {( {x}^{( 1 )} ( i ) )}^{*}\end{matrix} ] + [ \begin{matrix}{n}_{1} \\ {n}_{2}^{*}\end{matrix} ] \qquad [ Eqn . 18 ]$$

In order to detect x⁽⁰⁾(i), [(h⁽⁰⁾(2i))* h⁽¹⁾(2i)] is multiplied to both sides of Equation 11. Since the columns of the matrix in Equation 11 are orthogonal to each other, the multiplication results in the component of x⁽⁰⁾(i) becoming zero (0) in the equation. Thus, an interference-free detection for x⁽⁰⁾(i) can be done. Additionally, [(h⁽¹⁾(2i))* −h⁽⁰⁾(2i)] can be multiplied to both sides of Equation 11. Therefore, each symbol has been passed through two channel gains and the diversity is achieved for each pair of the symbols. Since the information stream is transmitted over antennas (space) and over different resource elements (either time or frequency), these schemes are referred to as Alamouti code space time-block code (STBC) or space frequency block code (SFBC).

FIG. 5 illustrates details of an Alamouti STBC with SC-FDMA precoder 500 according to one embodiment of the present disclosure. The embodiment of the Alamouti STBC with SC-FDMA precoder 500 shown in FIG. 5 is for illustration only. Other embodiments of the Alamouti STBC with SC-FDMA precoder 500 could be used without departing from the scope of this disclosure.

In some embodiments, Transmit Diversity (TxD) is introduced into SC-FDMA systems using Alamouti precoding. Alamouti SFBC and STBC are considered for 2-TxD in SC-FDMA systems. For example, in embodiments utilizing Alamouti STBC, two adjacent SC-FDMA symbols 505, 510 are paired, as illustrated in FIG. 5.

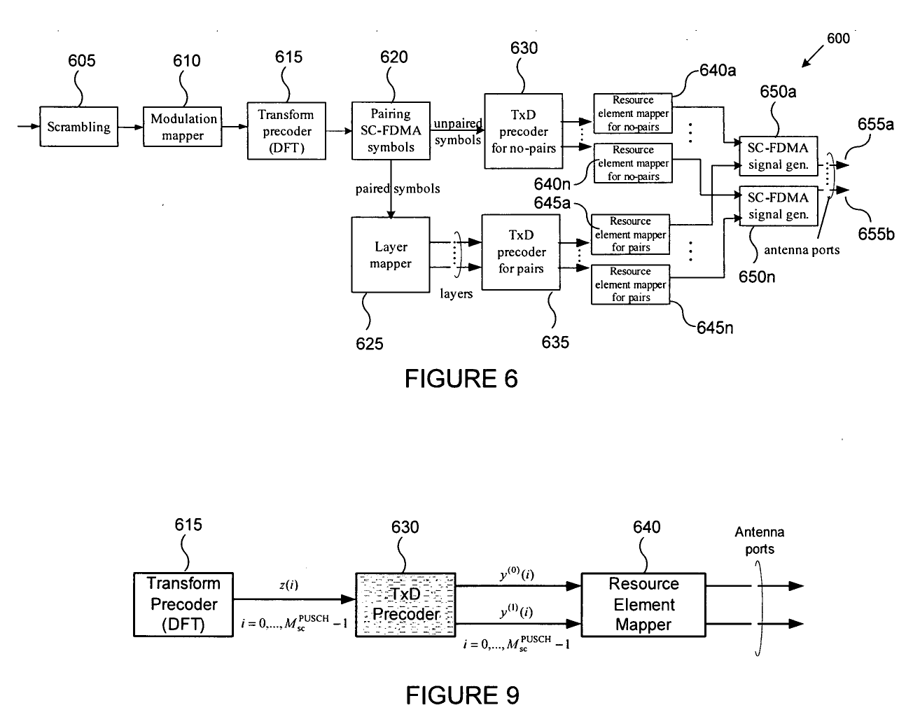

FIG. 6 illustrates a transmitter structure for 2-TxD schemes 600 according to one embodiment of the present disclosure. The embodiment of the transmitter structure for 2-TxD schemes 600 shown in FIG. 6 is for illustration only. Other embodiments of the transmitter structure for 2-TxD schemes 600 could be used without departing from the scope of this disclosure.

In some embodiments, transmitter structure for 2-TxD schemes 600 (hereinafter “transmitter” or “transmitter structure”) comprises a scrambling block 605 and a modulation mapper 610. Scrambling block 605 and modulation mapper 610 can be the same includes the same general structure and function as scrambling block 355 and a modulation mapper 360, discussed herein above with respect to FIG. 3B. The transmitter further includes a transform decoder 615, a SC-FDMA symbol pairing block 620 (hereinafter “pairing block”), a layer mapper 625, a TxD precoder for non-pairs 630 (hereinafter “non-pair precoder”), a TxD precoder for pairs 635 (hereinafter “paired precoder”), a plurality of resource element mappers for non-pairs 640 (hereinafter non-pair resource element mappers), a plurality of resource element mappers for pairs 645 (hereinafter pair resource element mappers), and a plurality of SC-FDMA signal generation blocks 650. The embodiment of the transmitter structure 600 illustrated in FIG. 6 is applicable to more than one physical channel. Although the illustrated embodiment shows two sets of components 640, 645 and 650 to generate two streams 655a-b for transmission by two antenna ports, it will be understood that transmitter 600 may comprise any suitable number of component sets 640, 645 and 650 based on any suitable number of streams 655 to be generated. Further illustration of the non-paired precoder 630 and the paired precoder 635 as separate elements merely is by way of example. It will be understood that the operations of non-paired precoder 630 and paired precoder 635 may be incorporated into a single component, or multiple components, without departing from the scope of this disclosure. At least some of the components in FIG. 6 may be implemented in software while other components may be implemented by configurable hardware or a mixture of software and configurable hardware.

An input to scrambling block 605 receives a block of bits. In some embodiments, the block of bits is encoded by a channel encoder. In some embodiments, the block of bits is not encoded by a channel encoder. The scrambling block 605 is operable to scramble the block of bits to be transmitted.

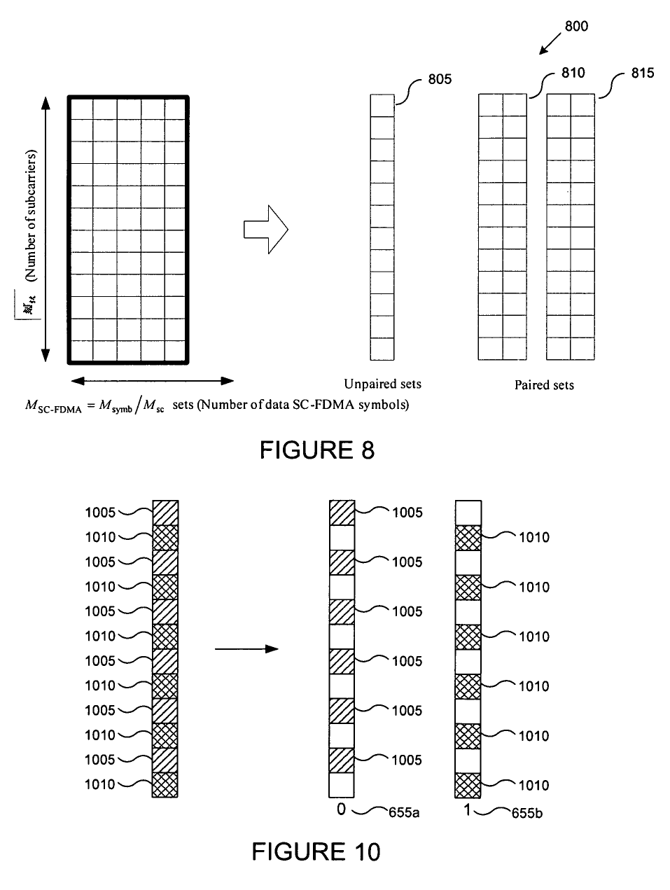

An input to the modulation mapper 610 receives the scrambled block of bits. The transmitter 600 is operable to perform modulation of the scrambled bits. The modulation mapper 610 modulates the block of scrambled bits. Modulation mapper 610 generates a block of symbols d(l·M_{sc}+i), where l=0, . . . , M_{SC-FDMA}−1, i=0, . . . , M_{sc}−1, M_{SC-FDMA} is the number of SC-FDMA symbols in a time slot devoted to data transmission and M_{sc} is the number of subcarriers that a UE (e.g., SS 116) is assigned for the transmission of the symbol block. M_{sc} is a multiple of four (4). The total number of symbols within the symbol block, M_{symb}, is the product of the number of SC-FDMA symbols and the number of subcarriers, or M_{sc}·M_{SC-FDMA}. The relation among these three numbers is illustrated in FIG. 8.

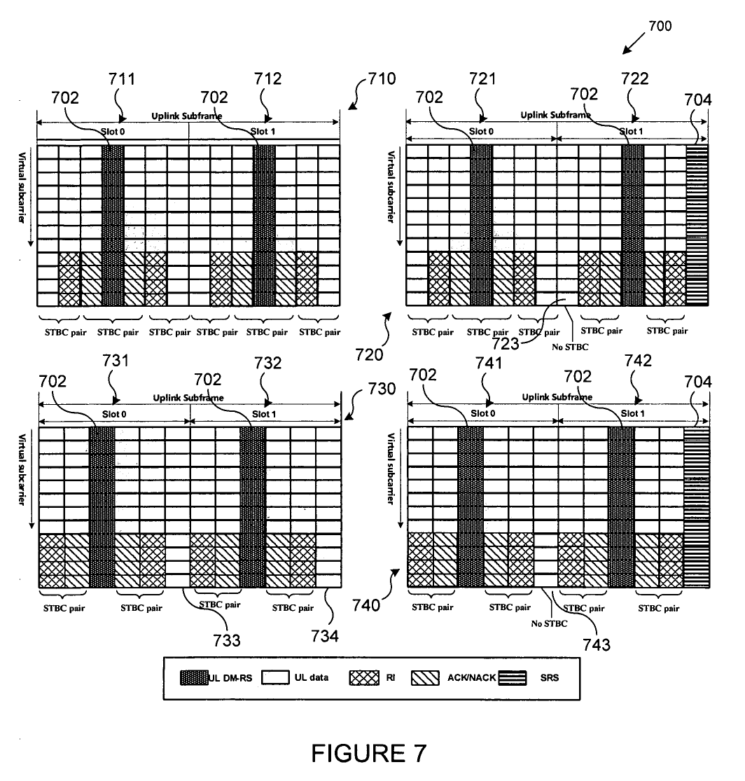

FIG. 7 illustrates UL subframe structures in LTE according to embodiments of the present disclosure. The embodiment of the subframe structures 700 shown in FIG. 7 is for illustration only. Other embodiments of the subframe structures 700 could be used without departing from the scope of this disclosure.

In different instances of the UL, the number of data symbols within a time slot 711, 712, 721, 722, 731, 732, 741, 742 702, 704 after excluding the RS symbols is either even or odd, as depicted in FIG. 7. When the number of data symbols is even (i.e., a multiple of two), SC-FDMA symbols can be paired such that an Alamouti STBC can be applied for all the paired symbols. However, when the number of data symbols is odd (i.e., not divisible by two), some data symbols cannot be paired. In such embodiments, when the number of data symbols is odd, a pairing operation results in an unpaired symbol, also referred to as an orphan symbol.

In some such embodiments, the data symbols in a time slot in the UL are paired until no more pairs can be identified and then for the paired symbols, Alamouti STBC shown in FIG. 5 is applied. If there exists an unpaired symbol (i.e., an orphan symbol) in a time slot, another TxD scheme is applied for that unpaired symbol.

FIG. 7 illustrates an exemplary way of pairing SC-FDMA symbols in an LTE subframe with different configurations. In both time slots 701, 702 in a normal-CP subframe without SRS 710, there are no unpaired symbols, since the number of data symbols is six (6) (which is even). In a normal-CP subframe with SRS 720, there are no unpaired symbols in time slot “0” 721. However, in time slot “1” 722, the first symbol 723 remains unpaired. In both time slots in an extended-CP subframe without SRS 730, the last symbol 733, 734 remains unpaired. Finally, in time slot “0” 741 in an extended-CP subframe with SRS 740, the last symbol 743 remains unpaired; in time slot “1” 742, all the data symbols are paired.

FIG. 8 illustrates a pairing operation 800 according to embodiments of the present disclosure. The embodiment of the pairing operation 800 shown in FIG. 8 is for illustration only. Other embodiments of the pairing operation 800 could be used without departing from the scope of this disclosure.

The pairing block 620 pairs a subset of the input sets zₗ(k), l=0, . . . , M_{SC-FDMA}−1, k=0, . . . , M_{sc}−1 paired sets 810, 815 and leaves the complement of the subset to remain as an unpaired orphan 805. The number of pairs constructed by the pairing block 620 is denoted by Mₚₐᵢᵣₛ. Further, pair n is composed of two input sets, pₙ⁽⁰⁾(k) and pₙ⁽¹⁾(k), where n=0, . . . , Mₚₐᵢᵣₛ−1 and k=0, . . . , M_{sc}−1. The number of orphan sets 805 is denoted by Mₙₒ₋ₚₐᵢᵣₛ. Further, orphan sets 805 are denoted by pₙ′(k), n=0, . . . , Mₙₒ₋ₚₐᵢᵣₛ−1. Thus, the number of symbols M_{symb} has a relation with Mₚₐᵢᵣₛ, Mₙₒ₋ₚₐᵢᵣₛ and M_{sc} as illustrated in Equation 19:

M_{symb}=M_{sc}(Mₙₒ₋ₚₐᵢᵣₛ+2Mₚₐᵢᵣₛ). [Eqn. 19]

In some embodiments, the number of data SC-FDMA symbols is even. In such embodiments, the pairing block 620 pairs two adjacent sets such that all the sets are paired. For example, pₙ⁽⁰⁾(k)=z₂ₙ(k) and pₙ⁽¹⁾(k)=z₂ₙ₊₁(k), for n=0, . . . , M_{SC-FDMA}/2−1, k=0, . . . , M_{sc}−1. Then, the number of pairs is Mₚₐᵢᵣₛ=M_{SC-FDMA}/2, and the number of orphans (i.e., unpaired sets) is Mₙₒ₋ₚₐᵢᵣₛ=0.

In some embodiments, the number of data SC-FDMA symbols is odd. In one such embodiment, the pairing block 620 does not pair the right-most set (e.g., the right-most set is unpaired). For example, pₙ⁽⁰⁾(k)=z₂ₙ(k) and pₙ⁽¹⁾(k)=z₂ₙ₊₁(k), for n=0, . . . , (M_{SC-FDMA}−1)/2−1; in addition, p₀′(k)=z_{SC-FDMA-1}(k). Then, the number of pairs is Mₚₐᵢᵣₛ=(M_{SC-FDMA}−1)/2 and the number of orphans is Mₙₒ₋ₚₐᵢᵣₛ=1.

In an additional and alternative embodiment where the number of data SC-FDMA symbols is odd, the pairing block 620 does not pair the left-most set (e.g., the left-most set is unpaired). For example, p₀′(k)=z₀(k); in addition, pₙ⁽⁰⁾(k)=z₂ₙ₊₁(k) and pₙ⁽¹⁾(k)=z₂ₙ₊₂(k), for n=0, . . . , (M_{SC-FDMA}−1)/2−1. Then, the number of pairs is Mₚₐᵢᵣₛ=(M_{SC-FDMA}−1)/2 and the number of orphans is Mₙₒ₋ₚₐᵢᵣₛ=1.

After the pairing operation, the transmitter 600 is operable to perform layer mapping on the paired sets using the layer mapper 625. The layer mapper 625 receives the paired sets from the pairing block 620. The transmitter 600 further is operable to allocate the orphan 805 and paired 810, 815 symbols using resource element mappers 640, 645.

FIG. 9 illustrates a detailed view of the transmitter components for unpaired symbols 900 according to one embodiment of the present disclosure. The embodiment of the transmitter components for unpaired symbols 900 shown in FIG. 9 is for illustration only. Other embodiments of the transmitter components for unpaired symbols 900 could be used without departing from the scope of this disclosure.

The transmitter for unpaired symbols 900 includes the same components as illustrated in the LTE uplink (UL) physical channel 350 illustrated in FIG. 3B and the transmitter structure illustrated in FIG. 6. As such, the transmitter for unpaired symbols 900 includes a scrambling block 605 (e.g., 355 illustrated in FIG. 3B), a modulation mapper 610 (e.g., 360 as illustrated in FIG. 3B), a transform precoder 615 (e.g., 365 as illustrated in FIG. 3B), a resource element mapper 640 (e.g., 370 as illustrated in FIG. 3B), and SC-FDMA signal generation block 650 (e.g., 375 as illustrated in FIG. 3B). Further, the transmitter for unpaired symbols 900 further includes a TXD precoder 630 coupled between the transform precoder 615 and the resource element mapper 640.

An input to the DFT 615 is the output generated by the modulation mapper 610 (illustrated in FIG. 6), which is d(l·M_{sc}+i). The DFT 615 generates z(i). The output z(i) is the DFT of the modulated symbol stream, where i is the frequency (or subcarrier) index, i=0, . . . , M_{sc}^{PUSCH}−1, and M_{sc}^{PUSCH} is the number of assigned subcarriers for the UL transmission of SS 116; y⁽⁰⁾(i),y⁽¹⁾(i) are the output of the TxD precoder 630 which will be mapped to a subcarrier in antenna ports “0” and “1”.

In some embodiments, the TxD precoder 630 outputs y⁽⁰⁾(i),y⁽¹⁾(i) are identical to the precoder input z(i), i.e., y⁽⁰⁾(i)=z(i),y⁽¹⁾(i)=z(i), for i=0, . . . , M_{sc}^{PUSCH}−1.

In some embodiments, the TxD precoder 630 output y⁽⁰⁾(i) is identical to TxD precoder 630 input z(i), while y⁽¹⁾(i) is zero, i.e., y⁽⁰⁾(i)=z(i),y⁽¹⁾(i)=0, for i=0, . . . , M_{sc}^{PUSCH}−1.

In some embodiments (e.g., FSTD top-down split), the TxD precoder 630 outputs y⁽⁰⁾(i) for the first half subcarriers are identical to TxD precoder 630 input z(i), while the outputs y⁽⁰⁾(i) for the second half subcarriers are zero. The second TxD precoder 630 outputs y⁽¹⁾(i) for the first half subcarriers are zero, while the outputs y⁽¹⁾(i) for the second half subcarriers are identical to the TxD precoder 630 input z(i). In other words, the outputs y⁽⁰⁾(i),y⁽¹⁾(i) of TxD precoder 630 are defined by Equations 20 and 21:

$$\begin{matrix}{y}^{( 0 )} ( i ) = \{ \begin{matrix}z ( i ) , & i = 0 , … , ( {M}_{sc}^{PUSCH} - 1 ) / 2 \\ 0 , & i = ( {M}_{sc}^{PUSCH} + 1 ) / 2 , … , {M}_{sc}^{PUSCH} - 1\end{matrix} ; & [ Eqn . 20 ] \\ {y}^{( 1 )} ( i ) = \{ \begin{matrix}0 , & i = 0 , … , ( {M}_{sc}^{PUSCH} - 1 ) / 2 \\ z ( i ) , & i = ( {M}_{sc}^{PUSCH} + 1 ) / 2 , … , {M}_{sc}^{PUSCH} - 1\end{matrix} . & [ Eqn . 21 ]\end{matrix}$$

In some embodiments (e.g., FSTD even-odd split), the TxD precoder 630 outputs y⁽⁰⁾(i) for the subcarriers with even indices are identical to the TxD precoder 630 input z(i), while the TxD precoder 630 outputs y⁽⁰⁾(i) for the subcarriers with odd indices are zero; the second TxD precoder 630 outputs y⁽¹⁾(i) for the subcarriers with even indices are zero, while the TxD precoder 630 outputs y⁽¹⁾(i) for the subcarriers with odd indices are identical to the TxD precoder 630 input z(i). In other words, the outputs y⁽⁰⁾(i),y⁽¹⁾(i) of the TxD precoder 630 are defined by Equations 22 and 23, for i=0, . . . , M_{sc}^{PUSCH}−1:

$$\begin{matrix}{y}^{( 0 )} ( i ) = \{ \begin{matrix}z ( i ) , & i = even \\ 0 , & i = odd\end{matrix} , & [ Eqn . 22 ] \\ {y}^{( 1 )} ( i ) = \{ \begin{matrix}z ( i ) , & i = odd \\ 0 , & i = even\end{matrix} . & [ Eqn . 23 ]\end{matrix}$$

FIG. 10 illustrates an even-odd TxD precoding method 1000 according to embodiments of the present disclosure. The embodiment of the even-odd TxD precoding method 1000 shown in FIG. 10 is for illustration only. Other embodiments of the even-odd TxD precoding method 1000 could be used without departing from the scope of this disclosure.

In some embodiments, the TxD precoder 630 utilizes an even-odd split method to map the orphan 805 into two groups for transmission over antenna port “0” 655a and antenna port “1” 655b. The TxD precoder 630 maps the elements at the even-th position of the input signal, i.e., pₙ′(k), k=2, 4, . . . , M_{sc}−2, for each n=0, . . . , Mₙₒ₋ₚₐᵢᵣₛ−1, to the corresponding subcarriers of the precoder output. Additionally, the TxD precoder 630 maps the elements at the odd-th position of the first half of the input signal, i.e., pₙ′(k), k=1, 3, . . . , M_{sc}−1, for each n=0, . . . , Mₙₒ₋ₚₐᵢᵣₛ−1, to the corresponding subcarriers of another precoder output. The subcarriers at each precoder output, onto which the input signal is not mapped, are filled with zeros. For example, the TxD precoding outputs are defined by Equations 24 and 25:

$$\begin{matrix}{y}^{′ ( 0 )} ( {nM}_{sc} + k ) = \{ \begin{matrix}{p}_{n}^{′} ( k ) , & for k = 0 , 2 , … , {M}_{sc} - 2 \\ 0 , & otherwise\end{matrix} . & [ Eqn . 24 ] \\ {y}^{′ ( 1 )} ( {nM}_{sc} + k ) = \{ \begin{matrix}{p}_{n}^{′} ( k ) , & for k = 1 , 3 , … , {M}_{sc} - 1 , \\ 0 , & otherwise\end{matrix} & [ Eqn . 25 ]\end{matrix}$$

In Equations 24 and 25, n=0, . . . , Mₙₒ₋ₚₐᵢᵣₛ−1.

The TxD precoder 630 maps the orphan 805 by mapping the even subcarriers 1005 to the even subcarriers of antenna port “0” 655a, while the odd subcarriers of antenna port “0” 655a are all set to zero (0). Further, the TxD precoder 630 maps the odd subcarriers 1010 to the odd subcarriers of antenna port “1” 655b, while the even subcarriers of antenna port “1” 655b are all set to zero (0).

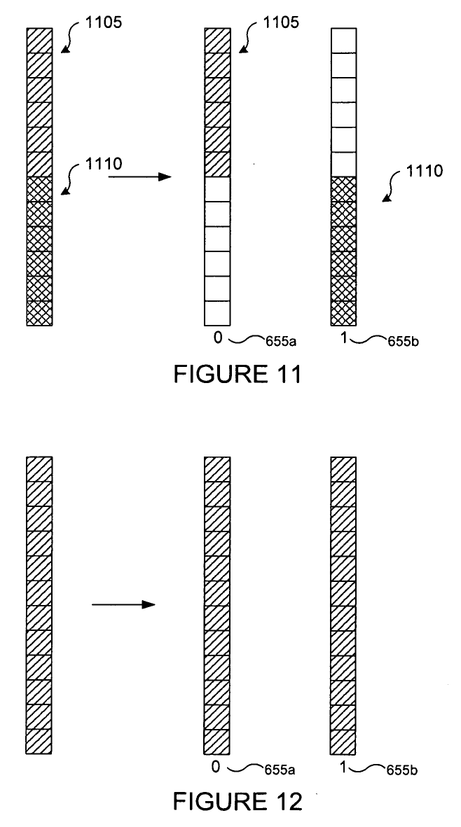

FIG. 11 illustrates a top-down split TxD precoding method 1100 according to embodiments of the present disclosure. The embodiment of the top-down split TxD precoding method 1100 shown in FIG. 11 is for illustration only. Other embodiments of the top-down split TxD precoding method 1100 could be used without departing from the scope of this disclosure.

In some embodiments, the TxD precoder 630 utilizes a top-down split TxD precoding method 1100 to precode the orphan 805. the non-paired precoder 630 utilizes a top-down split with single-antenna transmission TxD precoding method 1610 to precode the orphans 805. The TxD precoder 630 maps the top half of the input, i.e., pₙ′(k), k=0, . . . , M_{sc}/2−1 for each n=0, . . . , Mₙₒ₋ₚₐᵢᵣₛ−1, to the top half subcarriers of one precoder outputs. Additionally, the TxD precoder 630 maps the bottom half of the input, i.e., pₙ′(k), k=M_{sc}/2, . . . , M_{sc}−1, for each n=0, . . . , Mₙₒ₋ₚₐᵢᵣₛ−1, to the bottom half subcarriers of another precoder output. The mapping is performed in the increasing order of subcarrier index k, then n. The subcarriers at each precoder output, onto which the input signal is not mapped, are filled with zeros. For example, the TxD precoding outputs are defined by Equations 26 and 27:

$$\begin{matrix}{y}^{′ ( 0 )} ( {nM}_{sc} + k ) = \{ \begin{matrix}{p}_{n}^{′} ( k ) , & k = 0 , … , {M}_{sc} / 2 - 1 \\ 0 , & k = {M}_{sc} / 2 , … {M}_{sc} - 1\end{matrix} . & [ Eqn . 26 ] \\ {y}^{′ ( 2 )} ( {nM}_{sc} + k ) = 0 , \\ k = 0 , … , {M}_{sc} - 1. & [ Eqn . 27 ]\end{matrix}$$

In Equations 26 and 27, n=0, . . . , Mₙₒ₋ₚₐᵢᵣₛ−1.

The TxD precoder 630 maps the orphan 805 by mapping the top-half subcarriers 1105 to the top-half subcarriers of antenna port “0” 655a, while the bottom-half subcarriers of antenna port “0” 655a are all set to zero (0). Further, the TxD precoder 630 maps the bottom-half subcarriers 1110 to the even subcarriers of antenna port “1” 655b, while the top-half subcarriers of antenna port “1” 655b are all set to zero (0).

FIG. 12 illustrates a full TxD precoding method 1200 according to embodiments of the present disclosure. The embodiment of the full TxD precoding method 1200 shown in FIG. 12 is for illustration only. Other embodiments of the full TxD precoding method 1200 could be used without departing from the scope of this disclosure.

In some embodiments, the TxD precoder 630 and resource mapper 640 map all the subcarriers 1205 of the orphan onto all the subcarriers of each of antenna ports “0” 655a and “1” 655b.

In some embodiments, the paired sets 810, 815 are precoded using an Alamouti STBC, while the orphan 805 is precoded using a Frequency Shift Transmit Diversity (FSTD) scheme. In some embodiments, the paired sets 810, 815 are precoded using an Alamouti STBC while the orphan 805 is also precoded using an Alamouti STBC. In some embodiments, all the sets (e.g., orphan 805 and paired 810, 815) are transmitted using a FSTD scheme. In some embodiments, the paired sets 810, 815 are precoded using an FSTD scheme while the orphan 805 is precoded using an Alamouti STBC.

The non-pair resource element mappers 640 receives one of y′⁽⁰⁾(i) and y′⁽¹⁾(i) and maps the input symbols onto the physical time-frequency grid. In some embodiments, each of the inputs to the non-pair resource element mappers 640 y′⁽⁰⁾(i) and y′⁽¹⁾(i) are mapped to assigned resource elements of antenna ports 655, respectively (e.g., antenna ports “0”, and “1” respectively). The inputs are mapped in the increasing order of subcarrier index beginning from zero indices of assigned resources; each of the inputs to the pair resource element mappers 645 y⁽⁰⁾(i) and y⁽¹⁾(i) are then mapped to assigned resource elements of antenna ports 655, respectively (e.g., antenna ports “0”, and “1”, respectively). The inputs are mapped in the increasing order of subcarrier index, then in the increasing order of SC-FDMA symbol index, beginning from the last indices of the mapping for the no-pairs.

Finally, each SC-FDMA signal generator 650 generates a SC-FDMA signal by applying inverse fast Fourier transform (IFFT) on the output of its corresponding resource element mapper 640 and 645. The output of each SC-FDMA signal generator 650 is transmitted over the air through a physical antenna 655.

Demodulation reference signals in the 2 transmit-antenna SC-FDMA system:

For the demodulation of the received signal transmitted by the two-transmit-antenna (such as, but not limited to, the two-transmit-antenna diversity (2-TxD)) SC-FDMA transmitters, the channels between each transmit antenna and a receive antenna are separately measured utilizing dedicated pilots. To facilitate the separate measurement of reference signals at a subscriber station, the reference signals are transmitted in orthogonal dimensions.

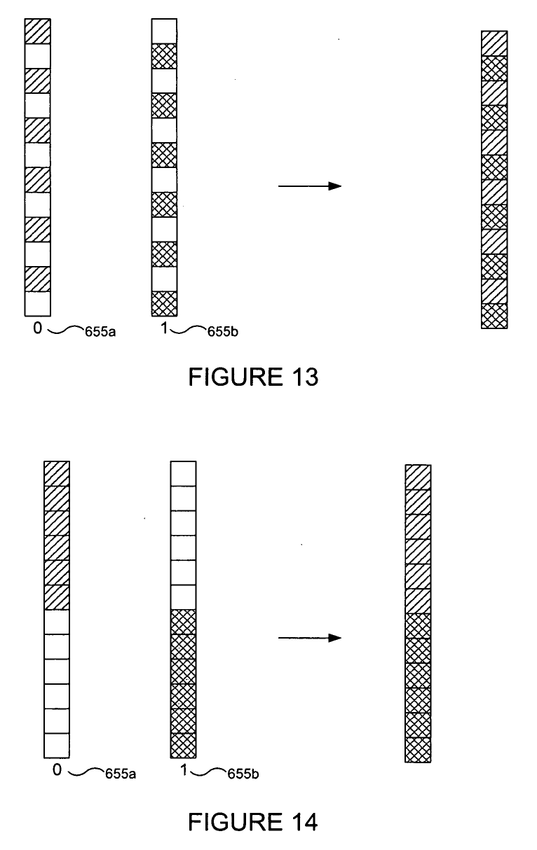

FIGS. 13 and 14 illustrate a DM-RS mapping method according to embodiments of the present disclosure. The embodiments of the DM-RS mapping methods 1300, 1400 shown in FIGS. 13 and 14 are for illustration only. Other embodiments of the DM-RS mapping methods 1300, 1400 could be used without departing from the scope of this disclosure.

A first method, using Code Division Multiplexing (CDM), assigns different cyclic shifts (CSs), defined in Equation 12, to each of the two reference sequences, defined in Equation 9, such that the two reference sequences are orthogonal to each other. Thus, two channels related to the two antennas are separately measured at the base station side. Two CSs are assigned per user. BS 102 informs SS 116 about the CS assignment information by transmitting to SS 116 a control message containing information regarding the two CSs. In the uplink transmission, SS 116 maps both reference signal sequences

In one embodiment, denoted as embodiment A, the base station 102 explicitly informs the SS 116 of the CS assignment by sending two different DM-RS CS bits, n_{DMRS,0}⁽²⁾ and n_{DMRS,1}⁽²⁾, defined in Equation 12, to SS 116 with a scheduling grant (or downlink control information (DCI) format “0” in GPP LTE 36.212). For this explicit indication, a secondary CS field is added to the existing DCI format “0”, a new DCI format with two (2) CS fields can be created.

Applying Equation 12 with n_{DMRS,0}⁽²⁾ and n_{DMRS,1}⁽²⁾ at SS 116, the two CSs for the two transmit antennas are obtained: n_{cs,0} and n_{cs,1}. Then, the reference sequences for the two transmit antennas are defined by Equations 28 and 29:

r_{u,v}^{(α}^{₀}⁾(n)=e^{jα}^{₀}ⁿ r̅_{u,v}(n), 0≦n<M_{sc}^{RS}, [Eqn. 28]

r_{u,v}^{(α}^{₁}⁾(n)=e^{jα}^{₁}ⁿ r̅_{u,v}(n), 0≦n<M_{sc}^{RS}. [Eqn. 29]

In Equations 28 and 29, α₀=2πn_{cs,0}/12 and α₁=2πn_{cs,1}/12. The reference sequences r_{u,v}^{(α}^{₀}⁾ and r_{u,v}^{(α}^{₁}⁾ are mapped to physical resources as follows. Sequence Generation: the demodulation reference signal sequence for antenna port p for PUSCH is denoted by rₚ^{PUSCH}(·) for p=0,1 and is defined by Equation 30:

rₚ^{PUSCH}(m·M_{sc}^{RS}+n)=r_{u,v}^{(α}^{ₚ}⁾(n). [Eqn. 30]

In Equation 30, m=0,1 is the slot index; n=0, . . . , M_{sc}^{RS}−1 is the subcarrier index and M_{sc}^{RS}=M_{sc}^{PUSCH}.

Physical Resource Mapping: Then, the sequence rₚ^{PUSCH}(·) is multiplied with the amplitude scaling factor β_{PUSCH} and mapped in sequence starting with rₚ^{PUSCH}(0) to the same set of physical resource blocks for antenna port p assigned for the corresponding PUSCH transmission. The mapping to resource elements (k,l), with l=3 for normal cyclic prefix and l=2 for extended cyclic prefix, in the subframe is in increasing order of first k, then the slot number.

In another embodiment illustrated in FIG. 13, using an even-odd split with two RS sequences, the two reference signal sequences are mapped onto the even-th elements at each SC-FDMA symbol on the sequences for antenna port “0”. Additionally, the two reference signal sequences are mapped onto the odd-th elements at each SC-FDMA symbol on the sequences for antenna ports “1”. For example, the demodulation reference signal sequence for antenna port p is denoted by rₚ(·) for p=0,1 and is constructed by Equations 31 and 32:

$$\begin{matrix}{r}_{0} ( m \cdot {M}_{sc} + n ) = \{ \begin{matrix}{r}_{u , v}^{( {α}_{0} )} ( n / 2 ) , & n is even \\ 0 , & n is odd\end{matrix} . & [ Eqn . 31 ] \\ {r}_{1} ( m \cdot {M}_{sc} + n ) = \{ \begin{matrix}0 , & n is even \\ {r}_{u , v}^{( {α}_{0} )} ( ( n - 1 ) / 2 ) , & n is odd\end{matrix} . & [ Eqn . 32 ]\end{matrix}$$

In Equations 31 and 32, m=0,1 is the slot index and n=0, . . . , M_{sc}−1.

Then, the sequence rₚ(·) shall be multiplied with the amplitude scaling factor β and mapped in sequence starting with rₚ(0) to the set of physical resources for antenna port p assigned for DM-RS transmission. The mapping to resource elements in the subframe is in increasing order of first the subcarrier index, then the slot number.

In another embodiment, denoted by DM-RS Sequence Construction B: (denoted by DM-RS Indication B), BS 102 implicitly informs CSs to a scheduled SS 116 by sending only one DM-RS CS index, n_{DMRS,0}⁽²⁾, to SS 116 with the scheduling grant. For this implicit indication, the existing DCI format “0” is reused for the indication of the single DMRS-CS. At SS 116, n_{DMRS,1}⁽²⁾ is obtained from a relation between N_{DMRS,0}⁽²⁾ and n_{DMRS,1}⁽²⁾. In one example, the relation is defined by Equation 33:

n_{DMRS,1}⁽²⁾=(n_{DMRS,0}⁽²⁾+6)mod 12. [Eqn. 33]

Once both n_{DMRS,0}⁽²⁾ and n_{DMRS,1}⁽²⁾ are available at the UE, the sequence generation and physical resource mapping are performed in the identical way as in the embodiment A (discussed herein above).

In one embodiment illustrated in FIG. 14, (denoted by DM-RS Sequence Construction A: top-down split with two RS sequences), the two reference signal sequences are mapped onto the first half elements at each SC-FDMA symbol on the sequences for antenna ports “0” and “2”, respectively. Additionally, the two reference signal sequences are mapped onto the last half elements at each SC-FDMA symbol on the sequences for antenna ports “1” and “3”, respectively. For example, the demodulation reference signal sequence for antenna port p is denoted by rₚ(·) for p=0, 1, 2, 3 and is constructed by Equations 34 and 35:

$$\begin{matrix}{r}_{0} ( m \cdot {M}_{sc} + n ) = \{ \begin{matrix}{r}_{u , v}^{( {α}_{0} )} ( n ) , & n = 0 , … , {M}_{sc} / 2 - 1 \\ 0 , & n = {M}_{sc} / 2 , … {M}_{sc} - 1\end{matrix} . & [ Eqn . 34 ] \\ {r}_{1} ( m \cdot {M}_{sc} + n ) = \{ \begin{matrix}0 , & n = 0 , … , {M}_{sc} / 2 - 1 \\ {r}_{u , v}^{( {α}_{0} )} ( n - {M}_{sc} / 2 ) , & n = {M}_{sc} / 2 , … {M}_{sc} - 1\end{matrix} . & [ Eqn . 35 ]\end{matrix}$$

In Equations 34-35, m=0,1 is the slot index.

In the uplink transmission, SS 116 maps both reference signal sequences in the same or similar manner as an LTE UE.

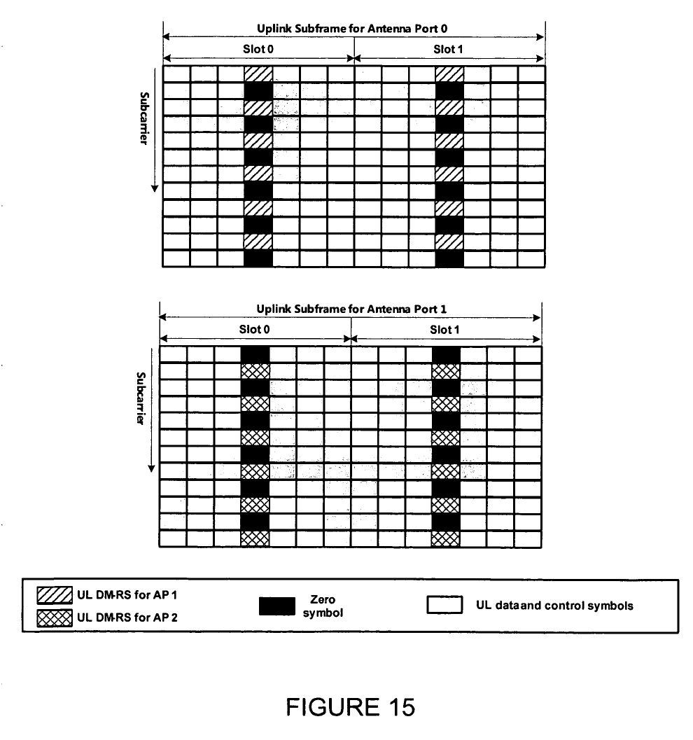

FIG. 15 illustrates a DM-RS FDM mapping method according to embodiments of the present disclosure. The embodiment of the DM-RS FDM mapping method 1500 shown in FIG. 15 is for illustration only. Other embodiments of the DM-RS FDM mapping method 1500 could be used without departing from the scope of this disclosure.

In a second method, the two reference signals are separated in a Frequency-Division Multiplexing (FDM) manner. In some embodiments of the second method, two identical reference sequences, each of which is equal to r_{u,v}^{(α)}, are constructed with a single DMRS-CS value for the two reference signals, where the length of the sequence is equal to the half of the number of assigned subcarriers M_{sc}^{PUSCH}. Thus, in this case, the existing DCI format “0” can be reused for the indication of the single DMRS-CS. For example, as shown in FIG. 13, the reference sequence for antenna port “0” is mapped onto the subcarriers with even indices; the reference sequence for antenna port “1” is mapped onto the subcarriers with odd indices. It will be understood that the mapping reference sequences onto the subcarriers can be performed in the opposite way without departing from the scope of this disclosure. For example, port-0 sequence can be mapped onto odd subcarriers, while port-1 sequence can be mapped onto even subcarriers. In other words, the demodulation reference signal sequence for antenna port p for PUSCH is denoted by rₚ^{PUSCH}(·) for p=0,1 and is defined by Equations 36 and 37:

$$\begin{matrix}{r}_{0}^{PUSCH} ( m \cdot {M}_{sc}^{RS} + n ) = \{ \begin{matrix}{r}_{u , v}^{( α )} ( \frac{n}{2} ) , & n even \\ 0 , & n odd\end{matrix} . & [ Eqn . 36 ] \\ {r}_{1}^{PUSCH} ( m \cdot {M}_{sc}^{RS} + n ) = \{ \begin{matrix}{r}_{u , v}^{( α )} ( \frac{n - 1}{2} ) , & n odd \\ 0 , & n even\end{matrix} . & [ Eqn . 37 ]\end{matrix}$$

In Equations 36 and 37, m=0,1 is the slot index; n=0, . . . , M_{sc}^{RS}−1 is the subcarrier index and M_{sc}^{RS}=M_{sc}^{PUSCH}.

Then, the physical resource mapping is performed as described with respect to embodiment A (discussed herein above).

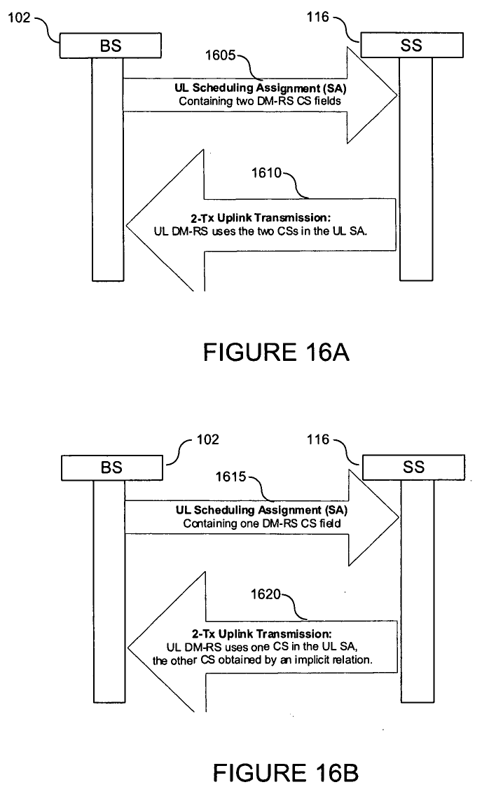

FIG. 16A illustrates an example DM-RS mapping method A according to embodiments of the present disclosure. The embodiments of the DM-RS mapping method A shown in FIG. 16A is for illustration only. Other embodiments of the DM-RS mapping method A could be used without departing from the scope of this disclosure.

BS 102 assigns different CSs to each of the reference sequences. For example, BS 102 can assign a first CS to a first demodulation reference signal and a second CS to a second demodulation reference signal. The CSs are assigned such that the two reference sequences are orthogonal to each other.

After the BS 102 performs the CS assignment, the BS 102 transmits a UL scheduling Assignment (SA) 1605 (also referred to as a “scheduling grant”) to the SS 116. The UL SA 1605 includes two DM-RS CS fields. Therefore, the BS 102 explicitly informs SS 116 regarding the CS assignment.

In response, the SS 116 transmits a UL transmission 1610 to BS 102. The SS 116 uses the CS assignment for the UL transmission 1610 to the BS 102. For example, the UL transmission 1610 can be a 2-Tx UL transmission using the two CSs received in the UL SA 1605.

FIG. 16B illustrates an example DM-RS mapping method B according to embodiments of the present disclosure. The embodiments of the DM-RS mapping method B shown in FIG. 16B is for illustration only. Other embodiments of the DM-RS mapping method B could be used without departing from the scope of this disclosure.

BS 102 assigns different CSs to each of the reference sequences. For example, BS 102 can assign a first CS to a first demodulation reference signal and a second CS to a second demodulation reference signal. The CSs are assigned such that the two reference sequences are orthogonal to each other.

After the BS 102 performs the CS assignment, the BS 102 transmits a UL scheduling Assignment (SA) 1615 (also referred to as a “scheduling grant”) to the SS 116. The UL SA 1615 includes one DM-RS CS field. Therefore, the BS 102 implicitly informs SS 116 regarding the CS assignment.

In response, the SS 116 computes the CS assignment based on the received one DM-RS CS field contained in the UL SA 1615. Thereafter, the SS 116 transmits a UL transmission 1620 to BS 102. The SS 116 uses the CS assignment for the UL transmission 1620 to the BS 102. For example, the UL transmission 1620 can be a 2-Tx UL transmission using the two CSs received in the UL SA 1615.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communications network, a subscriber station capable of wireless transmissions, the subscriber station comprising:
a transform precoder; and
a resource mapper, wherein said transform precoder and said resource mapper are configured to precode and map at least one symbol onto at least two antenna ports using a frequency shift transmit diversity scheme.

2. The subscriber station as set forth in claim 1, wherein the at least one symbol is an orphan symbol from an uplink subframe and wherein the orphan symbol is transmitted via a scheme different than a second symbol in the uplink subframe.

3. The subscriber station as set forth in claim 1, wherein the transform precoder and resource mapper are configured to precode and map every symbol in an uplink subframe to the at least two antenna ports using the frequency shift transmit diversity scheme.

4. The base station as set forth in claim 1, wherein the transform precoder is configured to precode at least a portion of the uplink subframe symbols using an Alamouti space time-block code.

5. The base station as set forth in claim 1, wherein the at least one symbol is mapped to the at least two antenna ports using at least one of a top-down split method and an even-odd split method.

6. A wireless communications network comprising a plurality of base stations capable of receiving transmissions from a plurality of subscriber stations, wherein at least one of the plurality of subscriber stations comprising:
a transform precoder; and
a resource mapper, wherein said transform precoder and said resource mapper are configured to precode and map at least one symbol onto at least two antenna ports using a frequency shift transmit diversity scheme.

7. The network as set forth in claim 6, wherein the at least one symbol is an orphan symbol from an uplink subframe and wherein the orphan symbol is transmitted via a scheme different than a second symbol in the uplink subframe.

8. The network as set forth in claim 6, wherein the transform precoder and resource mapper are configured to precode and map every symbol in an uplink subframe to the at least two antenna ports using the frequency shift transmit diversity scheme.

9. The network as set forth in claim 6, wherein the transform precoder is configured to precode at least a portion of the uplink subframe symbols using an Alamouti space time-block code.

10. The network as set forth in claim 6, wherein the at least one symbol is mapped to the at least two antenna ports using at least one of a top-down split method and an even-odd split method.

11. For use in a wireless communications network capable of multiple input multiple output transmissions, a method of uplink transmissions, the method comprising:
transmitting at least one symbol of an uplink subframe of symbols via at least two antenna ports using a frequency shift transmit diversity scheme.

12. The method as set forth in claim 11, wherein the at least one symbol is an orphan symbol and wherein the orphan symbol is transmitted via a scheme different than a second symbol in the uplink subframe.

13. The method as set forth in claim 12, further comprising pairing at least two symbols of a remaining number of symbols in the uplink subframe.

14. The method as set forth in claim 13, further comprising precoding at least a portion of the remaining number symbols using an Alamouti space time-block code.

15. The method as set forth in claim 11, wherein every symbol in the uplink subframe is transmitted using a frequency shift transmit diversity scheme.

16. The method as set forth in claim 11, further comprising a mapping the at least one symbol onto the at least two antenna ports using at least one of a top-down split method and an even-odd split method.

17. The method as set forth in claim 11, further comprising:
assigning a number of cyclic shifts to a number of demodulation reference signals, wherein a first cyclic shift to a first demodulation reference signal and a second cyclic shift to a second demodulation reference signal; and
transmitting demodulation reference signals.

18. The method as set forth in claim 17, further comprising explicitly informing a subscriber station regarding the assignment of at least one cyclic shift.

19. The method as set forth in claim 18, further comprising deriving at least one cyclic shift for a subscriber station from the explicitly informed assignment of the at least one cyclic shift utilizing a relation.

20. A subscriber station capable of wireless transmissions, the subscriber station comprising:
a transform precoder; and
a resource mapper, wherein said subscriber station is configured to:
receive a number of cyclic shift assignments, said number of cyclic shift assignments comprising an assignment of a first cyclic shift to a first demodulation reference signal and a second cyclic shift to a second demodulation reference signal; and
apply the cyclic shifts to the demodulation reference signals in an uplink transmission.

21. The subscriber station as set forth in claim 20, wherein the subscriber station is configured to receive at least one cyclic shift explicitly.

22. The subscriber station as set forth in claim 21, wherein the subscriber station is configured to derive at least one cyclic shift for a subscriber station from the explicitly informed assignment of, the at least one cyclic shift utilizing a relation
